(19) United States
(12) Patent Application Publication
(10) Pub. No.: US 2012/0265461 A1
(43) Pub. Date: Oct. 18, 2012

(54) ELECTRONIC DEVICE AND SYSTEM TIME SETTING METHOD THEREOF

(75) Inventors: GUO-ZHI DING, Shanghai (CN); AI-JUN SHEN, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 13/207,436

(22) Filed: Aug. 11, 2011

(30) Foreign Application Priority Data
Apr. 15, 2011 (CN) 201110094683.8

(51) Int. Cl. G06F 19/00

(52) U.S. Cl. 702/63

(57) ABSTRACT

A system time setting function for an electronic device includes a battery module, a clock module, a processing module and a storage module. The battery module includes a battery gauge integrated chip which times in cycles and measuring a remaining battery capacity. The clock module generates a system time T0 when the electronic device is powered on. The processing module obtains and stores an oscillation time T1 and a remaining battery capacity C1 from the gauge integrated chip. The processing module further obtains a current oscillation time T2 and a currently measured remaining battery capacity C2 and calculates the period for which the electronic device has been powered off and further determines the current system Te according to that length of time, the stored system time T0, the current remaining battery capacity C2 and the stored remaining battery capacity C1.

### BACKGROUND

1. Technical Field

The present disclosure relates to electronic devices, and particularly, to an electronic device with a system time setting function and a method thereof.

2. Description of Related Art

The system time of some electronic devices, for example mobile phones, may be lost when the batteries of the electronic devices are taken out. When the electronic devices are powered on again, the system time may be inconsistent with the standard time, thus users have to go through the trouble of resetting the system time which may include year, month, date, and time.

### BRIEF DESCRIPTION OF THE DRAWINGS

Many aspects of the present disclosure may be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device in accordance with an exemplary embodiment.

FIGS. 2A-2B show a flowchart of a system time setting method in accordance with an exemplary embodiment.

### DETAILED DESCRIPTION

Embodiments of the present disclosure will now be described in detail below, with reference to the accompanying drawings.

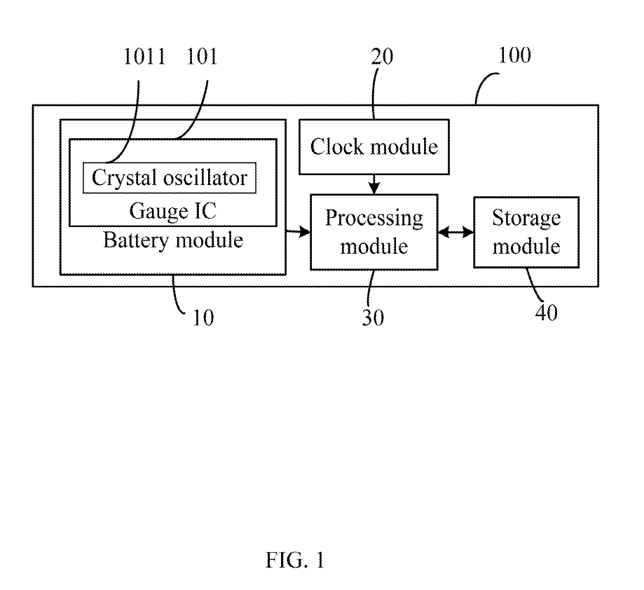

Referring to FIG. 1, an electronic device 100 includes a battery module 10, a clock module 20, a processing module 30, and a storage module 40. The battery module 10 is configured to supply power to the electronic device 100. The battery module 10 includes a battery identifier (not shown) for identifying the battery module 10 and a battery gauge integrated chip (gauge IC) 101 for measuring remaining battery capacity C1 of the battery module 10. The gauge IC 101 includes a crystal oscillator 1011 therein for the repeated timing of a set period. In this embodiment, the oscillation period of the crystal oscillator 1011 is 65,535 seconds (18 hours). The clock module 20 is configured to provide a system time T0 when the electronic device 100 is in a power-on state.

When the electronic device 100 is in the power-on state, the processing module 30 obtains the system time T0, the measured remaining battery capacity C1, and the time elapsed since the start of the most recent timing (oscillation time T1) by the crystal oscillator 1011, and updates the storage module 40 to store the currently obtained system time T0, the currently measured remaining battery capacity C1, and the current oscillation time T1 in the storage module 40. In this embodiment, the storage module 40 further stores a battery capacity consumption value C0 which records a rate of loss of battery capacity per hour of the battery module 10 when the battery 10 is not supplying power to the electronic device 100, for example, when the battery 10 has been taken out of the electronic device 100. The processing module 30 further obtains the battery identifier of the battery module 10 mounted therein once the electronic device 100 is powered on, and updates the storage module 40 to store any data from the currently obtained battery identifier in the storage module 40 if no battery identifier exists in the storage module 40, or if the previously stored data from the battery identifier is shown to be different from that of the currently identifier.

When the electronic device 100 is powered on, the processing module 30 determines whether the battery module 10 currently existing in the electronic device 100 is different from the battery module 10 previously existing in the electronic device 100, that is, it determines whether the battery module 10 has been changed. If the battery module 10 has been changed, the processing module 30 obtains a current oscillation time T2 from the gauge IC 101, and calculates the time length for which the electronic device 100 has been powered-off according to the current oscillation time T2 and the stored oscillation time T1, where the length of time may be equal to the current oscillation time T2 minus the stored oscillation time T1 if T2>T1, or equal to a total of 65,535 seconds and the value of the current oscillation time T2 minus the stored oscillation time T1, if T2<T1. The processing module 30 further compares the current remaining battery capacity C2 of the battery module 10 with the stored remaining battery capacity C1, and determines the current system Te according to the length of time, the stored system time T0, the comparison result between the current remaining battery capacity C2 and the stored remaining battery capacity C1, and the battery capacity consumption value C0. In this embodiment, the processing module 30 further generates a prompt to the user to reset the system time based on the calculated current system time Te. In the execution of such a function, the current system time Te may be not totally accurate, but users only need to reset the minutes or seconds to regulate, or re-regulate, the current system Te to obtain the system time Te without being required to reset the year, the date, and the hour.

In this embodiment, when the electronic device 100 is powered on, the processing module 30 obtains data from the battery identifier of the battery module 10 currently existing in the electronic device 100, and determines whether the currently obtained data from the battery identifier is different from that of the stored battery identifier. If it is not, the electronic device 100 determines that the battery module 10 is unchanged. If it is, the electronic device 100 determines that the battery module 10 has been changed, and replaces the previously stored data as to the battery identifier with the currently obtained data from the battery identifier. In this embodiment, if the electronic device 100 determines that the battery module 10 has been changed when the electronic device 100 is powered on, the processing module 30 sets a total of the stored system time T0 plus a predetermined time as the current system time Te. In this embodiment, the predetermined time may be an average time of a user changing the battery module 10, for example 60 seconds.

In this embodiment, if the processing module 30 determines that the battery module 10 is not changed, when the electronic device 100 is powered on, the processing module 30 obtains the current remaining battery capacity C2 and the current oscillation time T2 from the gauge IC 101.

The processing module 30 determines whether the current remaining battery capacity C2 is greater than the stored remaining battery capacity C1, and whether the current oscillation time T2 is greater than the stored oscillation time T1. If the current remaining battery capacity C2 is greater than the stored remaining battery capacity C1 and the current oscillation time T2 is greater than the oscillation time T1, the processing module 30 determines the current system time according to the formula Te=T0+(T2−T1). If the current remaining battery capacity C2 is greater than the stored battery capacity C1 and the current oscillation time T2 is less than the stored oscillation time T1, the processing module 30 determines the current time according to the formula Te=T0+65535+(T2−T1).

If the current remaining battery capacity C2 is less than the stored remaining battery capacity C1 and the current oscillation time T2 is greater than the stored oscillation time T1, the processing module 30 determines a battery discharge time Tc=(C1−C2)/C0, where Tc is measured in hours, and determines the current system time Te according to the formula Te=[Tc div 18]*65535+T0+(T2−T1), here, div represents an integer division. If the current oscillation time T2 is less than the stored oscillation time T1, the processing module 30 determines the current system time Te according to the formula Te=[Tc div 18]*65535+T0+65535+(T2−T1).

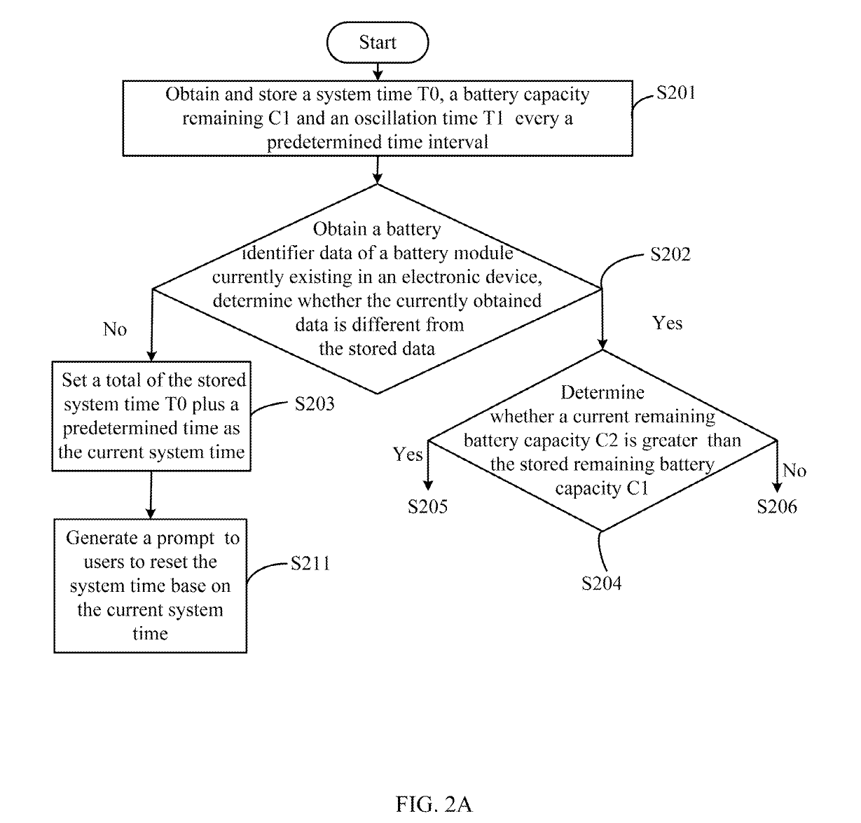

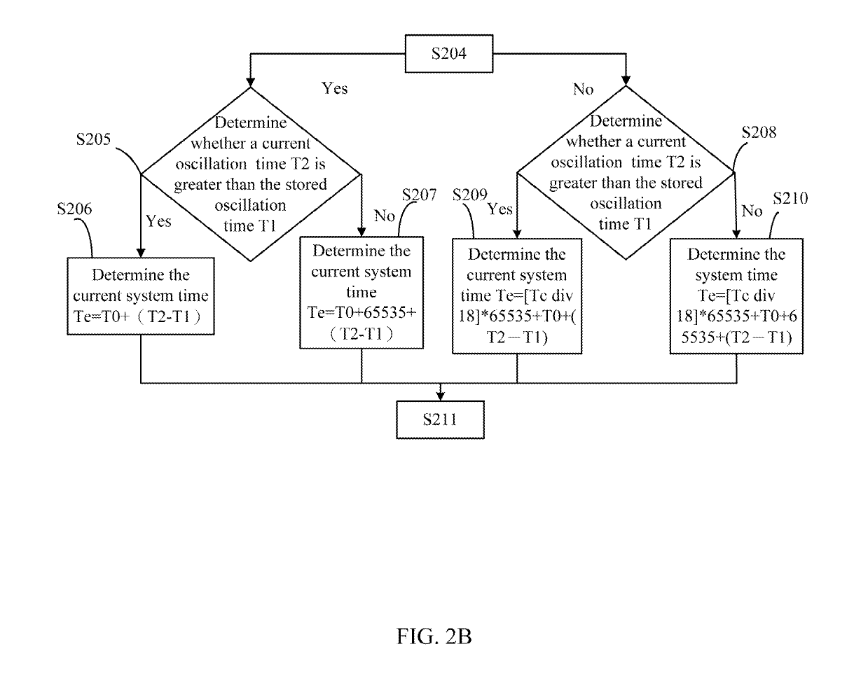

FIGS. 2A-2B show a flowchart of a system time setting method in accordance with an exemplary embodiment.

In step S201, the processing module 30 obtains the system time T0, the currently measured remaining battery capacity C1, and the oscillation time T1 generated by the crystal oscillator 1011 every predetermined time interval when the electronic device 100 is in an power-on state, and updates the storage module 40 to store the currently obtained system time T0, the currently measured remaining battery capacity C1, and the current oscillation time T1 in the storage module 40.

In step S202, when the device 100 is powered on, the processing module 30 obtains the battery identifier data concerning the battery module 10 currently existing in the electronic device 100, and determines whether the currently obtained data is different from the stored data. If it is, the procedure goes to step S203; if it is not, the procedure goes to step S204.

In step S203, when the electronic device 100 is powered on, the processing module 30 sets the total of the stored system time T0 plus a predetermined time T3 as the current system time Te.

In step S204, the processing module 30 obtains a current remaining battery capacity C2 from the gauge IC 101 and determines whether the current batter capacity C2 is greater than the stored remaining battery capacity C1. If it is, the procedure goes to step S205, otherwise the procedure goes to step S208.

In step S205, the processing module 30 obtains a current oscillation time T2, and determines whether the current oscillation time T2 is greater than the stored oscillation time T1, if it is, the procedure goes to step S206; if it is not, the procedure goes to step S207.

In step S206, the processing module 30 determines the current system time according to the formula Te=T0+(T2−T1).

In step S207, the processing module 30 determines the current system time according to the formula Te=T0+65535+(T2−T1).

In step S208, the processing module 30 determines whether the current oscillation time T2 is greater than the stored oscillation time T1, if it is, the procedure goes to step S209; otherwise, the procedure goes to step S210.

In step S209, the processing module 30 determines a battery discharge time as Tc=(C2−C1)/C0, and determines the current system time according to the formula Te=[Tc div 18]*65535+T0+(T2−T1).

In step S210, the processing module 30 determines the current system time according to the formula Te=[Tc div 18]*65535+T0+65535+(T2−T1).

In step S211, the processing module 30 generates a prompt to the user to reset the system time base on the current system time Te.

The present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. An electronic device with a system setting function, comprising:
a storage module storing a battery capacity consumption value C0 recording a rate of loss of battery capacity per hour for a battery when the battery is not supplying power to the electronic device;
a battery module to supply power to the electronic device, and comprising a battery gauge integrated chip for measuring remaining battery capacity of the battery module and repeated timing of a set period, the battery module comprising a battery identifier;
a clock module to provide a system time T0 when the electronic device is in an power-on state;
a processing module to obtain the system time T0 from the clock module, a measured remaining battery capacity C1, and the time elapsed since the start of the most recent timing (oscillation time T1) by the gauge integrated chip every a predetermined time interval, and update the storage module to store the currently obtained system time T0, the currently measured remaining battery capacity C1, the current oscillation time T1; the processing module further to determine whether the battery module is changed according to the data from battery identifier of the battery module, obtain a current oscillation time T2 from the gauge integrated chip if the battery module is not changed, and calculate the time length the electronic device being powered off according to the current oscillation time T2 and the stored oscillation time T1, the time length being equal to the current oscillation time T2 minus the stored oscillation time T1 if T2>T1 or equal to a total of 65,535 and the value of the current oscillation time T2 minus the stored oscillation time T1 if T2<T1, the processing module further to compare the current remaining battery capacity C2 of the battery module with the stored remaining battery capacity C1, and determine the current system Te according to the time length, the stored system time T0, the comparison result between the current remaining battery capacity C2 and the stored remaining battery capacity C1, and the battery capacity consumption value C0.

2. The electronic device as described in claim 1, wherein the gauge integrated chip comprises a crystal oscillator therein for the repeated timing of a set period, and the oscillation period of the crystal oscillator is 65,535 seconds.

3. The electronic device as described in claim 1, wherein the processing module is further to obtain the data from battery identifier of the battery module currently existing in the electronic device once the electronic device is powered on, determine the battery module is changed if the data from currently obtained battery identifier is different from the stored data from battery identifier, and replace the previously stored data as to the battery identifier with the currently obtained data from the battery identifier if the battery module is changed.

4. The electronic device as described in claim 3, wherein the processor is further to set a total of the stored system time T0 plus a predetermined time as the current system time Te if the battery module is changed.

5. The electronic device as described in claim 4, wherein the processing module is further to determine whether the current remaining battery capacity C2 is greater than the stored remaining battery capacity C1 and whether the current oscillation time T2 is greater than the stored oscillation time T1 if the battery module is not changed, the processing module is to determine the current system time according to a formula Te=T0+(T2−T1) if C2>C1 and T2>T1; the processing module is to determine the current time according to a formula Te=T0+65535+(T2−T1) if C2>C1 and T2<T1; the processing module is to determine a battery discharge time Tc=(C1−C2)/C0, wherein the unit of the Tc is hour, and the current system time Te=[Tc div 18]*65535+T0+(T2−T1) if C2<C1 and T2>T1; if C2<C1 and T2<T1, the processing module is to determine the current system time according to a formula Te=[Tc div 18]*65535+T0+65535+(T2−T1) if C2<C1 and T2>T1.

6. The electronic device as described in claim 5, wherein the processing module is further to generate a prompt information to prompt the user to reset the system time base on the current system time Te.

7. A system time setting method applied in an electronic device, the electronic device comprising a battery module with a gauge integrated chip measuring a remaining battery capacity of the battery module and repeated timing in a period of 65,535 seconds, a clock module, a processing module, and a storage module storing a battery capacity consumption value C0 recording a rate of loss of battery capacity per hour of a battery module when the battery is not supplying power to the electronic device, the method comprising:
obtaining a system time T0 generated by the clock module, the measured remaining battery capacity C1, and an oscillation time T1 generated by the gauge integrated chip every a predetermined time interval and updating the storage module to store the currently obtained system time T0, the currently measured remaining battery capacity C1, and the current oscillation time T1;
obtaining a battery identifier data concerning of the battery module currently existing in the electronic device, and determining whether the data from currently obtained battery identifier is different from that of the stored battery identifier when the electronic device is in an power-on state;
obtaining a current oscillation time T2 from the gauge integrated chip if the battery module is not changed, and calculating the time length the electronic device being powered off according to the current oscillation time T2 and the stored oscillation time T1; and
comparing a current remaining battery capacity C2 of the battery module with the stored remaining battery capacity C1, and determining a current system Te according to the time length, the stored system time T0, the comparison result between the current remaining battery capacity C2 and the stored remaining battery capacity C1, and a battery capacity consumption value C0.

8. The system time setting method as described in claim 7, wherein the method calculating the time length the electronic device being powered off according to the current oscillation time T2 and the stored oscillation time T1 further comprises:
determining the time length being equal to the current oscillation time T2 minus the stored oscillation time T1 if T2>T1 or equal to a total of 65,535 seconds and the value of the current oscillation time T2 minus the stored oscillation time T1 if T2<T1.

9. The system time setting method as described in claim 8, wherein the method “determining a current system Te according to the time length, the stored system time T0, the comparison result between the current remaining battery capacity C2 and the stored remaining battery capacity C1, and a battery capacity consumption value C0” comprises:
obtaining a current remaining battery capacity C2 from the gauge integrated chip and determining whether the current batter capacity C2 is greater than the stored remaining battery capacity C1 if the data from battery identifier is the same as that of the stored battery identifier;
determining the current system time Te according to a formula Te=T0+(T2−T1) if the current remaining battery capacity C2 is greater than the stored remaining battery capacity C1 and the current oscillation time T2 is greater than the stored oscillation time T1;
determining the current system time Te according to a formula Te=T0+65535+(T2−T1) if the current remaining battery capacity C2 is greater than the stored remaining battery capacity C1 and the current oscillation time T2 is less than the stored oscillation time T1;
determining the current system time Te according to a formula Te=[(C1−C2)/C0 div 18]*65535+T0+(T2−T1) if the current remaining battery capacity C2 is less than the stored remaining battery capacity C1 and the current oscillation time T2 is greater than the stored oscillation time T1; and
determining the current system time Te=[(C1−C2)/C0 div 18]*65535+65535+T0+(T2−T1) if the current remaining battery capacity C2 is less than the stored remaining battery capacity C1 and the current oscillation time T2 is less than the stored oscillation time T1.

10. The system time setting method as described in claim 7, wherein the method further comprises:
setting a total of the stored system time T0 plus a predetermined time T3 as the current system time Te if the data from battery identifier is different from that of the stored battery identifier.

11. The system time setting method as described in claim 9, wherein the method further comprises:
generating a prompt information to prompt the user to reset the system time base on the current system time Te.

12. The system time setting method as described in claim 10, wherein the method further comprises:
generating a prompt information to prompt the user to reset the system time base on the current system time Te.
